(19) United States
(12) Patent Application Publication
(10) Pub. No.: US 2016/0190941 A1
(43) Pub. Date: Jun. 30, 2016

(54) SWITCHING POWER SUPPLY SYSTEM, AND ASSOCIATED CONTROL CIRCUIT TO ELIMINATE FLICKER OF LED

(71) Applicant: Chengdu Monolithic Power Systems Co., Ltd., Chengdu (CN)

(72) Inventor: Naixing Kuang, Hangzhou (CN)

(21) Appl. No.: 14/971,994

(22) Filed: Dec. 16, 2015

(30) Foreign Application Priority Data
Dec. 25, 2014 (CN) 201410821777.4

(51) Int. Cl. H02M 3/335; H05B 33/08

(52) U.S. Cl. CPC H02M 3/33507; H05B 33/0815; H05B 33/0845

(57) ABSTRACT

A switching power supply system has a switching circuit and a control circuit. The control circuit has an integrating circuit providing a charge signal by integrating an output current feedback signal, a charge control circuit, and a switching control circuit controlling the switching circuit based on the charge signal and a charge reference signal. The switching power supply system controls an output current stable via controlling the charge signal, so as to eliminate flicker and shimmer of a LED load with low power loss and simple circuit.

### CROSS-REFERENCE TO RELATED APPLICATION

This application claims the benefit of CN application No. 201410821777.4, filed on Dec. 25, 2014, and incorporated herein by reference.

### TECHNICAL FIELD

The present invention relates to electrical circuit, more particularly but not exclusively relates to switching power supply system, and control circuit for eliminating flicker of LED (light emitting diode).

### BACKGROUND

TRIAC (triode alternating current switch) dimmer is widely used in LED applications for dimming. A TRIAC dimmer regulates power delivered from an AC (alternating current) power supply (usually 110V-220V) to a switching converter by controlling a conduction angle of the TRIAC dimmer to cut off part of the AC power supply. The conduction angle represents an on time period of the TRIAC dimmer in a cycle in degrees or radians. However, disturbance on the AC power supply will influence a cut off time of the conduction angle, which will introduce flicker for a LED load. To solve this problem, a bleeding circuit with adjustable resistance is often employed to get a stable output from the TRIAC dimmer. But one drawback of this method is that power loss will be increased, which will increase cost for a heat sink and will lead to poor efficiency. Another method is using a two stage switching converter to drive the LED load, for example employing a boost converter as a first stage, and a flyback converter as a second stage. But disadvantages of this method are high BOM (bill of materials) cost and big circuit size.

As a result, a switching power supply system with a stable output to drive a LED load is needed, even for applications without dimming.

### SUMMARY

It is one of the objects of the present invention to provide a switching power supply system, control circuit and associated control method.

One embodiment of the present invention discloses a control circuit for a switching power supply system, the switching power supply system comprises a switching circuit having an input voltage, an input current and an output current, the control circuit comprising: an integrating circuit, configured to receive an output current feedback signal representative of the output current, and configured to provide a charge signal by integrating the output current feedback signal; a charge control circuit, having a first input terminal, a second input terminal and an output terminal, wherein the first input terminal is configured to receive the charge signal, and the second input terminal is configured to receive a charge reference signal; and a switching control circuit, having an input terminal and an output terminal, wherein the input terminal is coupled to the output terminal of the charge control circuit, and the output terminal is configured to provide a switching control signal to control the switching circuit based on the charge signal and the charge reference signal.

Another embodiment of the present invention discloses a switching power supply system, comprising: a rectifier circuit, having an input terminal and an output terminal, wherein the input terminal is configured to receive an AC input voltage, and the output terminal is configured to provide an input voltage via rectifying the AC input voltage; a switching circuit, having an input terminal and an output terminal, wherein the input terminal is coupled to the output terminal of the rectifier circuit to receive the input voltage, and wherein the switching circuit further comprises a power switch having a control terminal, the output terminal of the switching circuit is configured to provide an output current to drive a load via turning ON and turning OFF the power switch; and a control circuit, configured to provide a charge signal by integrating an output current feedback signal representative of the output current, and the control circuit is configured to provide a switching control signal to control the power switch based on the charge signal.

Yet another embodiment of the present invention discloses a control method for a switching power supply system, the switching power supply system comprises a switching circuit having an input voltage, an input current and an output current, the control method comprising: providing a charge signal by integrating an output current feedback signal representative of the output current; providing a modulated input voltage signal via controlling a gain of the input voltage based on the charge signal and a charge reference signal; controlling the switching circuit based on the modulated input voltage signal; and judging if the charge signal is larger than the charge reference signal; wherein when the charge signal is larger than the charge reference signal, turning OFF the switching circuit and decreasing the gain of the input voltage; and wherein when the charge signal is less than the charge reference signal, increasing the gain of the input voltage.

Embodiments of the present invention eliminate flicker and shimmer of a LED load with low power loss and simple circuit.

### BRIEF DESCRIPTION OF THE DRAWINGS

Non-limiting and non-exhaustive embodiments are described with reference to the following drawings.

FIG. 1 shows waveforms of an AC input voltage Vac, an input voltage Vin rectified from AC input voltage Vac, or input voltage Vin rectified from a dimmed AC input voltage according to an embodiment of the present invention.

FIG. 2 schematically illustrates a switching power supply system 200 according to an embodiment of the present invention.

FIG. 3 schematically illustrates a switching power supply system 300 according to an embodiment of the present invention.

FIG. 4 shows waveforms of a dimmed AC input voltage Vtr and input voltage Vin rectified from dimmed AC input voltage Vtr according to an embodiment of the present invention.

FIG. 5 schematically illustrates a switching power supply system 500 according to an embodiment of the present invention.

FIG. 6 schematically illustrates a charge reference signal generator 52 according to an embodiment of the present invention.

FIG. 7 shows waveforms of switching power supply system 500 according to an embodiment of the present invention.

FIG. 8 shows simulation waveforms 8A of a conventional switching power supply system with a TRIAC dimmer and simulation waveforms 8B of a switching power supply system with the TRIAC dimmer according to an embodiment of the present invention.

FIG. 9 shows a flow chart illustrating a control method 900 for a switching power supply system to eliminate flicker and shimmer of a LED load according to an embodiment of the present invention.

The use of the same reference label in different drawings indicates the same or like components.

### DETAILED DESCRIPTION

In the present application, numerous specific details are provided, such as examples of circuits, components, and methods, to provide a thorough understanding of embodiments of the invention. These embodiments are exemplary, not to confine the scope of the invention. Persons of ordinary skill in the art will recognize, however, that the invention can be practiced without one or more of the specific details. In other instances, well-known details are not shown or described to avoid obscuring aspects of the invention. Some phrases are used in some exemplary embodiments. However, the usage of these phrases is not confined to these embodiments.

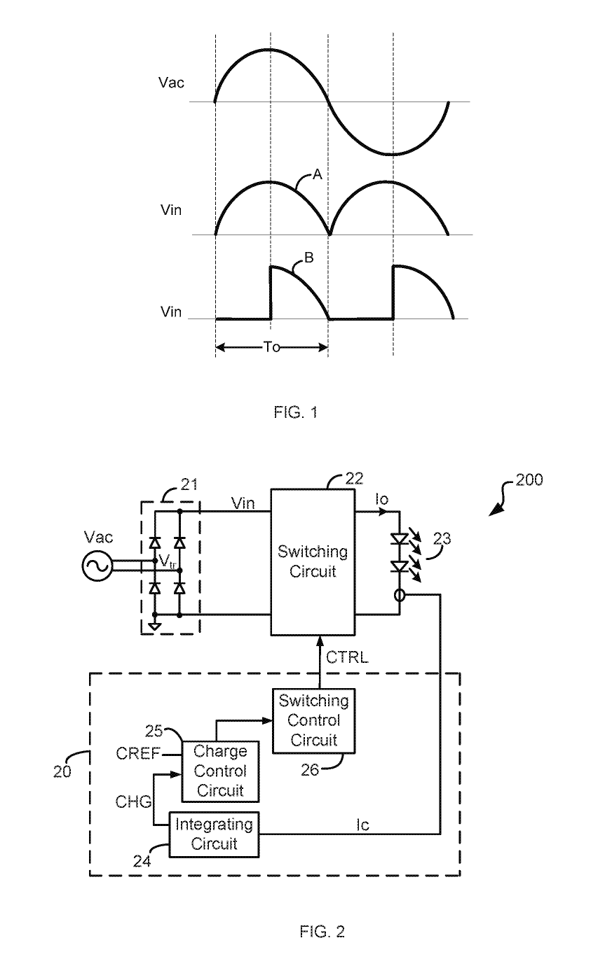

FIG. 1 shows waveforms of an AC input voltage Vac, an input voltage Vin rectified from AC input voltage Vac, or input voltage Vin rectified from a dimmed AC input voltage according to an embodiment of the present invention. A switching power supply system receives AC input voltage Vac, and provides input voltage Vin via rectifying AC input voltage Vac. AC input voltage Vac is a grid voltage for one example. As shown in FIG. 1, input voltage Vin directly rectified from AC input voltage Vac is shown as waveform A, and input voltage Vin rectified from the dimmed AC input voltage is shown as waveform B. An input cycle To of input voltage Vin is shown in FIG. 1, which is also a half wave cycle of AC input voltage Vac. Embodiments followed are to control a total charge of an output current of the switching power supply system within each input cycle To to make the output current stable.

FIG. 2 schematically illustrates a switching power supply system 200 according to an embodiment of the present invention. Switching power supply system 200 comprises a rectifier circuit 21, a switching circuit 22, a load 23 and a control circuit 20. Rectifier circuit 21 is configured to provide input voltage Vin as waveform A shown in FIG. 1 via rectifying AC input voltage Vac. Rectifier circuit 21 may be a diode-bridge rectifier as shown in FIG. 2. In another embodiment, rectifier circuit 21 may comprise other forms of rectifier circuit. Switching circuit 22 is configured to receive input voltage Vin and provide an output current Io to load 23. In one embodiment, switching circuit 22 employs step-down converter. In other embodiments, switching circuit 22 may employ step-up converter, isolated converter, or non-isolated converter. In the embodiment shown in FIG. 2, load 23 is a LED device. In other embodiments, load 23 may be other types of lighting device or even non-lighting device. Take the LED device as an example, switching circuit 22 should provide stable output current Io to drive the LED device. Control circuit 20 receives an output current feedback signal Ic representative of output current Io, and provides a switching control signal CTRL to control switching circuit 22 based on output current feedback signal Ic. In one embodiment, output current feedback signal Ic is obtained by sensing output current Io directly. In another embodiment, output current feedback signal Ic is obtained based on sensing a current flowing through other parts of switching power supply system 200. Control circuit 20 is configured to calculate a total charge of output current Io within each input cycle To based on output current feedback signal Ic, and control the total charge of output current Io within each input cycle To equals a predetermined value. Specifically, control circuit 20 comprises an integrating circuit 24, a charge control circuit 25 and a switching control circuit 26. Integrating circuit 24 receives output current feedback signal Ic, and provides charge signal CHG representative of the total charge of output current Io by integrating current feedback signal Ic. Integrating circuit 24 may adopt any suitable integrating circuit which performs a mathematical operation of integration with respect to time. Charge control circuit 25 receives charge signal CHG and a charge reference signal CREF, and is configured to compare charge signal CHG with charge reference signal CREF. Switching control circuit 26 is configured to provide switching control signal CTRL based on a comparing result between charge signal CHG and charge reference signal CREF. In one embodiment, the comparing result between charge signal CHG and charge reference signal CREF is a logic signal. In another embodiment, the comparing result between charge signal CHG and charge reference signal CREF is an error amplifier signal. Switching control signal CTRL is configured to control output current Io by turning ON and turning OFF a switch in switching circuit 22. Flicker or shimmer of the LED device is eliminated by controlling the charge signal CHG to follow charge reference signal CREF.

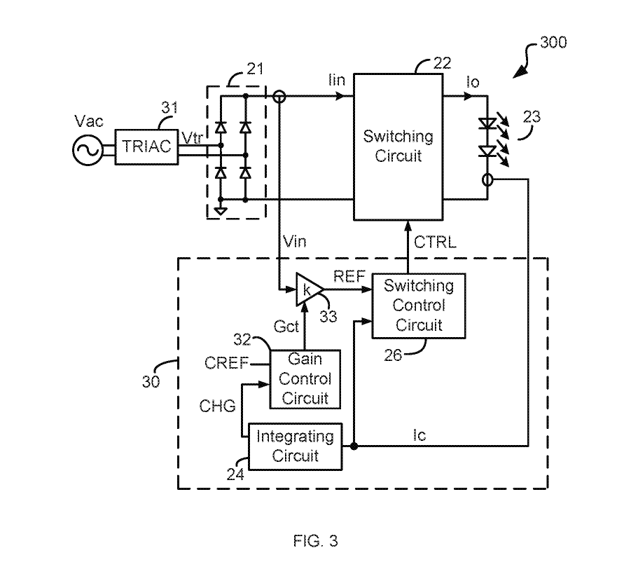

FIG. 3 schematically illustrates a switching power supply system 300 according to an embodiment of the present invention. Switching power supply system 300 is configured to control a gain of input voltage Vin based on the comparing result between charge signal CHG and charge reference signal CREF, and configured to provide a modulated input voltage signal REF based on input voltage Vin and the gain of input voltage Vin to control switching circuit 22. Switching power supply system 300 comprises a TRIAC dimmer 31, rectifier circuit 21, switching circuit 22, load 23 and a control circuit 30.

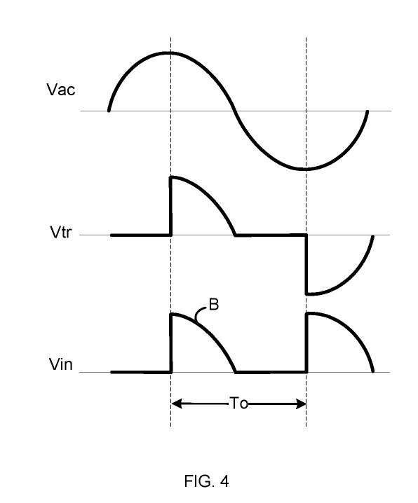

TRAIC dimmer 31 has an input terminal configured to receive AC input voltage Vac, and an output terminal configured to provide a dimmed AC input voltage Vtr. TRIAC dimmer 31 is employed to provide dimmed AC input voltage Vtr via cutting off part of AC input voltage Vac. FIG. 4 shows waveforms of dimmed AC input voltage Vtr and input voltage Vin rectified from dimmed AC input voltage Vtr according to an embodiment of the present invention. In the embodiment shown in FIG. 4, TRIAC dimmer 31 is a leading edge dimmer. In another embodiment, TRIAC dimmer 31 may be a trailing edge dimmer. Rectifier circuit 21 has an input terminal coupled to the output terminal of TRIAC dimmer 31 to receive dimmed AC input voltage Vtr, and an output terminal configured to provide input voltage Vin. Switching circuit 22 has an input terminal coupled to the output terminal of rectifier circuit 21 to receive input voltage Vin, and an output terminal configured to provide output current Io to drive load 23. In the embodiment shown in FIG. 3, control circuit 30 receives output current feedback signal Ic, and provides charge signal CHG via integrating output current feedback signal Ic over each input cycle To.

Control circuit 30 comprises integrating circuit 24, switching control circuit 26, and a charge control circuit comprising a gain control circuit 32 and a multiplying circuit 33. Integrating circuit 24 is coupled to switching circuit 22 to receive output current feedback signal Ic, and provides charge signal CHG via integrating output current feedback signal Ic over each input cycle To. Gain control circuit 32 has a first input terminal, a second input terminal and an output terminal, wherein the first input terminal of gain control circuit 32 is coupled to integrating circuit 24 to receive charge signal CHG, the second input terminal of gain control circuit 32 is configured to receive charge reference signal CREF, and the output terminal of gain control circuit 32 is configured to provide a gain modulation signal Gct based on charge signal CHG and charge reference signal CREF. Multiplying circuit 33 has an input terminal, an output terminal and a control terminal, wherein the input terminal of multiplying circuit 33 is coupled to the input terminal of switching circuit 22 to receive input voltage Vin, the control terminal of multiplying circuit 33 is coupled to the output terminal of gain control circuit 32 to receive gain modulation signal Gct, and the output terminal of multiplying circuit 33 is configured to provide modulated input voltage signal REF. Switching control circuit 26 receives modulated input voltage signal REF and feedback signals, such as output current feedback signal Ic, an input current feedback signal representative of an input current Iin, and provides switching control signal CTRL to control switching circuit 22 based on modulated input voltage signal REF and feedback signals. In one embodiment, switching power supply system 300 employs power factor correction (PFC) control, and input current Iin will follow modulated input voltage signal REF, wherein input current Iin may be calculated from output current feedback signal Ic based on a relationship between output current Io and input current Iin. In another embodiment, switching control circuit 26 receives the input current feedback signal directly, and provides switching control signal CTRL to control switching circuit 22 based on modulated input voltage signal REF and the input current feedback signal. In another embodiment, signal Ic is the input current feedback signal representative of input current Iin, an output current feedback signal is calculated from the input current feedback signal, and charge signal CHG is obtained by integrating the calculated output current feedback signal. Switching power supply system 300 is configured to control the gain of input voltage Vin based on the comparing result between charge signal CHG and charge reference signal CREF. As a result, input current Iin follows modulated input voltage signal REF, and charge signal CHG follows charge reference signal CREF. Thus, the total charge of output current Io within each input cycle To is controlled, the flicker or shimmer is eliminated or depressed accordingly.

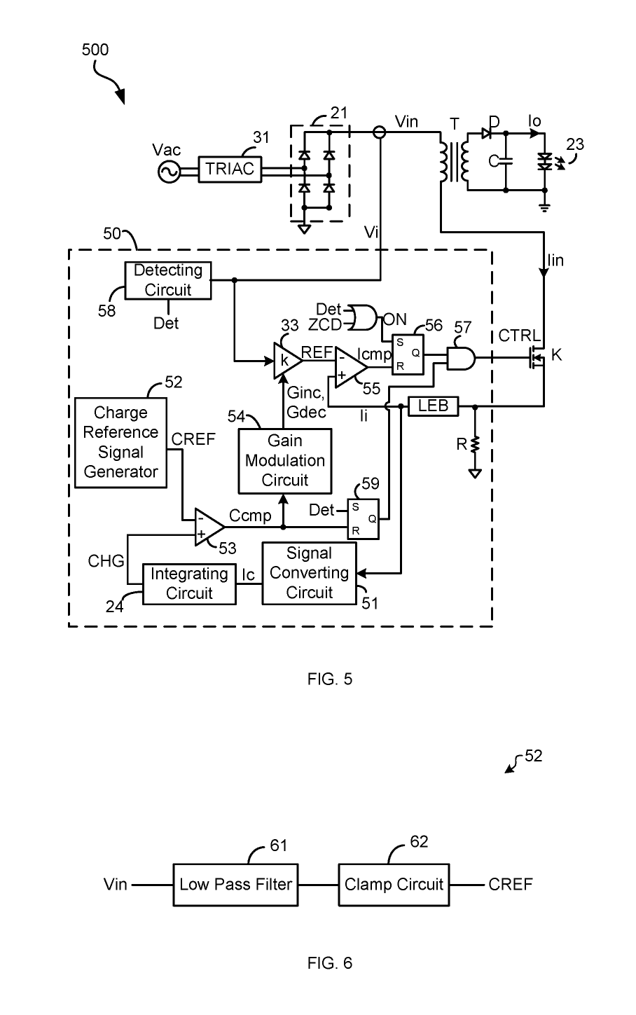

FIG. 5 schematically illustrates a switching power supply system 500 according to an embodiment of the present invention. Switching power supply system 500 adopts PFC control as one example. Switching power supply system 500 comprises TRIAC dimmer 31, rectifier circuit 21, a switching circuit and a control circuit 50. In the embodiment shown in FIG. 5, the switching circuit comprises a flyback converter having a power switch K, a transformer T, a secondary rectifier diode D and an output capacitor C. Control circuit 50 receives input current Iin of the flyback converter, and controls a peak value of input current Iin to follow input voltage Vin. A signal converting circuit 51 provides output current feedback signal Ic based on an input current feedback signal Ii representative of input current Iin.

Control circuit 50 comprises a current feedback circuit, signal converting circuit 51, integrating circuit 24, a charge reference signal generator 52, a charge comparison circuit 53, a gain modulation circuit 54, a first latch circuit 59, multiplying circuit 33, an AND gate 57, and a switching control circuit comprising a current comparison circuit 55 and a second latch circuit 56. Control circuit 50 further comprises a detecting circuit 58 configured to detect a status of input voltage Vin and provide a detecting signal Det. In one embodiment, when input voltage Vin jumps, for example, varies from zero to a high voltage, detecting circuit 58 provides detecting signal Det having a pulse to indicate that a new input cycle begins. In the embodiment shown in FIG. 5, TRIAC dimmer 31 is a leading edge dimmer, detecting signal Det is a high voltage level pulse when input voltage Vin jumps from zero to the high voltage, and a time period between two successive leading edge of detecting signal Det equals input cycle To. In another embodiment, TRIAC dimmer 31 is a trailing edge dimmer, and detecting signal Det is a high voltage level pulse when input voltage Vin jumps from the high voltage to zero. The current feedback circuit comprises a resistor R and a leading edge blanking (LEB) circuit. The current feedback circuit is configured to sense input current Iin through sensing a current flowing through power switch K, and is configured to provide input current feedback signal Ii. Signal converting circuit 51 is configured to receive input current feedback signal Ii and is configured to provide output current feedback signal Ic via mathematical calculating.

In another embodiment, output current feedback signal Ic is obtained by sensing a secondary current. Integrating circuit 24 is coupled to an output terminal of signal converting circuit 51 to receive output current feedback signal Ic, and provides integrating signal CHG via integrating output current feedback signal Ic. Charge reference signal generator 52 is configured to provide charge reference signal CREF. In one embodiment, charge reference signal generator 52 is configured to provide charge reference signal CREF based on an average value of input voltage Vin within a plurality of successive input cycles.

FIG. 6 schematically illustrates charge reference signal generator 52 according to an embodiment of the present invention. Charge reference signal generator 52 comprises a low pass filter 61 and a clamp circuit 62. Low pass filter 61 comprises an input terminal and an output terminal, the input terminal of low pass filter 61 is configured to receive input voltage Vin, and the output terminal of low pass filter 61 is configured to provide the average value of input voltage Vin via implementing a low pass filtering operation on input voltage Vin during a time period. In one embodiment, the time period for the low pass filtering operation is several successive input cycles. Clamp circuit 62 is coupled to the output terminal of low pass filter 61 to receive the average value of input voltage Vin and provides charge reference signal CREF, wherein charge reference signal CREF is updated to equal the average value of the input voltage Vin at an end of the time period for the low pass filtering operation. Low pass filer 61 may employ any suitable circuit having a low pass filtering function. Clamp circuit 62 may be any suitable circuit having a holding and an outputting function.

Continuing with FIG. 5, charge comparison circuit 53 has an inverting terminal, a non-inverting terminal, and an output terminal, wherein the non-inverting terminal of charge comparison circuit 53 is coupled to the output terminal of integrating circuit 24 to receive charge signal CHG, the inverting terminal of charge comparison circuit 53 is coupled to the output terminal of charge reference signal generator 52 to receive charge reference signal CREF, and the output terminal of charge comparison circuit 53 is configured to provide a charge comparison signal Ccmp via comparing charge signal CHG with charge reference signal CREF. In another embodiment, the inverting terminal and the non-inverting terminal of charge comparison circuit 53 may exchange. Gain modulation circuit 54 has an input terminal and an output terminal, wherein the input terminal of gain modulation circuit 54 is coupled to the output terminal of charge comparison circuit 53 to receive charge comparison signal Ccmp, and the output terminal of gain modulation circuit 54 is coupled to the control terminal of multiplying circuit 33 to provide a gain increasing signal Ginc and a gain decreasing signal Gdec based on charge comparison signal Ccmp. Gain increasing signal Ginc and gain decreasing signal Gdec are employed to modulate the gain of input voltage Vin. Multiplying circuit 33 provides modulated input voltage signal REF as an input current reference signal. In one embodiment, when gain increasing signal Ginc is a valid state, e.g., logic high, and gain decreasing signal Gdec is a invalid state, e.g., logic low, the gain of input voltage Vin increases; when gain increasing signal Ginc is the invalid state and gain decreasing signal Gdec is the valid state, the gain of input voltage Vin decreases; when both of gain increasing signal Ginc and gain decreasing signal Gdec is the valid state, the gain of input voltage Vin remains; and when both of gain increasing signal Ginc and gain decreasing signal Gdec is the invalid state, the gain of input voltage Vin remains. The first latch circuit 59 is configured to receive charge comparison signal Ccmp to turn OFF power switch K when charge signal CHG is larger than charge reference signal CREF. The first latch circuit 59 has a reset terminal R, a set terminal S and an output terminal Q, wherein the reset terminal R of the first latch circuit 59 is coupled to the output terminal of charge comparison circuit 53, the set terminal S of the first latch circuit 59 is coupled to detecting circuit 58 to receive detecting signal Det, and the output terminal Q of the first latch circuit 59 is coupled to a first input terminal of AND gate 57. When charge signal CHG is larger than charge reference signal CREF, charge comparison signal Ccmp is logic high to reset the first latch circuit 59, and AND gate 57 provides switching control signal CTRL with logic low to turn OFF power switch K. When the new input cycle begins, detecting signal Det is configured to set the first latch circuit 59, and switching control signal CTRL provided by AND gate 57 is controlled by the switching control circuit. In one embodiment, switching power supply system 500 comprises a driver coupled between AND gate 57 and power switch K to provide a suitable voltage for driving power switch K. A charge control circuit comprises charge reference signal generator 52, charge comparison circuit 53, gain modulation circuit 54, multiplying circuit 33, the first latch circuit 59 and AND gate 57. A gain control circuit comprises charge comparison circuit 53 and gain modulation circuit 54.

In another embodiment, the gain control circuit further comprises an error amplifier. The error amplifier is configured to provide an error amplifier signal via amplifying a difference between charge signal CHG and charge reference signal CREF, and the gain control circuit is configured to control the gain of input voltage Vin based on the error amplifier signal.

When charge signal CHG is larger than charge reference signal CREF, charge comparison signal Ccmp is logic high, gain modulation circuit 54 is configured to decrease the gain of input voltage Vin, and then modulated input voltage signal REF decreases. When charge signal CHG keeps lower than charge reference signal CREF during input cycle To, charge comparison signal Ccmp is logic low, gain modulation circuit 54 is configured to increase the gain of input voltage Vin, and then modulated input voltage signal REF increases.

Current comparison circuit 55 has a non-inverting terminal, an inverting terminal and an output terminal, wherein the non-inverting terminal of current comparison circuit 55 is coupled to the current feedback circuit to receive input current feedback signal Ii, the inverting terminal of current comparison circuit 55 is coupled to multiplying circuit 33 to receive modulated input voltage signal REF, and the output terminal of current comparison circuit 55 is configured to provide a current comparison signal Icmp via comparing input current feedback signal Ii with modulated input voltage signal REF. The second latch circuit 56 has a set terminal S, a reset terminal R, and an output terminal Q, wherein the set terminal S of the second latch circuit 56 is configured to receive a set signal ON, the reset terminal R of the second latch circuit 56 is coupled to the output terminal of current comparison circuit 55 to receive current comparison signal Icmp, and the output terminal Q of current comparison circuit 55 is coupled to the control terminal of power switch K. When set signal ON is logic high, the second latch circuit 56 is set to turn ON power switch K, wherein set signal ON is generated through an OR operation on detecting signal Det and a zero current detecting (ZCD) signal of input current Iin, i.e., when input current Iin decreases to zero or the new input cycle begins, set signal ON becomes logic high to set the second latch circuit 56. When input current feedback signal Ii increases larger than modulated input voltage signal REF, the second latch circuit 56 is reset to turn OFF power switch K. That is input current feedback signal Ii is compared with modulated input voltage signal REF, and when a peak value of input current feedback signal Ii equals modulated input voltage signal REF, power switch K is turned OFF to control the peak value of input current feedback signal Ii following modulated input voltage signal REF. Integrating circuit 24 provides charge signal CHG by integrating output current feedback signal Ic. The gain of input voltage Vin is regulated to control the total charge of output current Io based on the comparing result between charge signal CHG and charge reference signal CREF. Since the total charge of output current Io is controlled stable, output current Io is stable.

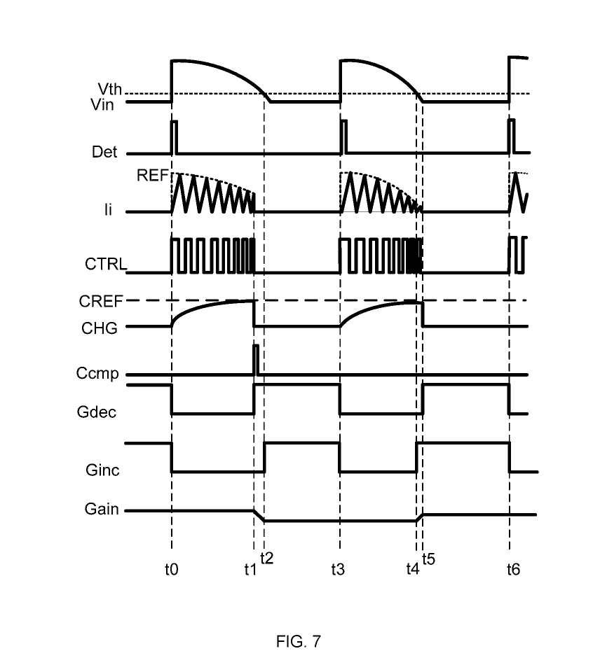

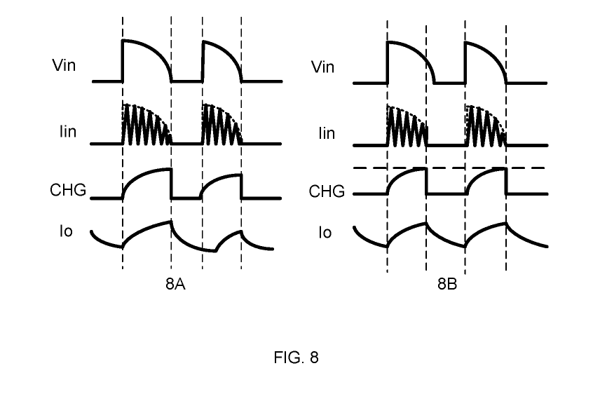

FIG. 7 shows waveforms of switching power supply system 500 according to an embodiment of the present invention. FIG. 7 shows input voltage Vin, input current feedback signal Ii, modulated input voltage signal REF, charge reference signal CREF, charge signal CHG, charge comparison signal Ccmp, gain increasing signal Ginc, gain decreasing signal Gdec, and the gain Gain of input voltage Vin. A detailed working process regarding control circuit 50 shown in FIG. 5 is described hereinafter.

At time t0, TRIAC dimmer 31 is turned ON, input voltage Vin increases from zero quickly, detecting signal Dec is a high voltage pulse, one input cycle begins. Set signal ON becomes logic high to set the second latch circuit 56, switching control signal CTRL becomes logic high to turn ON power switch K, input current feedback signal Ii increases, output current Io increases and charge signal CHG increases. When input current feedback signal Ii increases to modulated input voltage signal REF, switching control signal CTRL becomes logic low to turn OFF power switch K, and then input current feedback signal Ii decreases. When input current feedback signal Ii decrease to zero, ZCD signal becomes logic high to provide high logic set signal, switching control signal CTRL becomes logic high to turn ON power switch K again, input current feedback signal Ii increases again until reaches modulated input voltage signal REF. Input voltage Vin decreases, the peak value of input current feedback signal Ii during each switching cycle decreases with input voltage Vin, and charge signal CHG increases slowly. PFC control is achieved that the peak value of input current feedback signal Ii follows modulated input voltage signal REF. At time t1, charge signal CHG increases to charge reference signal CREF, charge comparison signal Ccmp becomes logic high to reset the first latch circuit 59 shown in FIG. 5, and AND gate 57 provides logic low switching control signal CTRL to turn OFF power switch K. Although input voltage Vin is positive, input current Iin is zero, and charge signal CHG equals charge reference signal CREF. Meanwhile, gain decreasing signal Gdec becomes logic high, and gain Gain decreases accordingly. At time t2, input voltage Vin decreases to a predetermined voltage threshold Vth, gain increasing signal Ginc becomes logic high, and gain Gain remains. At time t3, TRIAC dimmer 31 is turned ON again, input voltage Vin increases from zero quickly, detecting signal Dec is high voltage pulse, another input cycle begins, gain increasing signal Ginc and gain decreasing signal Gdec becomes logic low at the same time. Set signal ON becomes logic high to set the second latch circuit 56, and power switch K is turned ON. As shown in FIG. 7, gain Gain decreases during input cycle t0-t3. At time t4, input voltage Vin decreases to predetermined voltage threshold Vth, gain increasing signal Ginc becomes logic high, gain Gain increases accordingly. At time t5, input voltage Vin decreases to zero, gain decreasing signal Gdec becomes logic high, and then gain Gain remains. In one embodiment, when input voltage Vin decrease to a voltage threshold Vth2 lower than predetermined voltage threshold Vth, gain decreasing signal Gdec becomes logic high. At time t6, another input cycle begins, gain increasing signal Ginc and gain decreasing signal Gdec becomes logic low at the same time. As shown in FIG. 7, gain Gain increases during time interval t4-t5, which ensures a suitable value of modulated input voltage signal REF for next input cycle. When input voltage Vin decreases, time t4 is brought forward, time interval t4-t5 becomes longer, and gain Gain becomes larger. As a result, charge signal CHG is controlled to follow charge reference signal CREF.

FIG. 8 shows simulation waveforms 8A of a conventional switching power supply system with a TRIAC dimmer and simulation waveforms 8B of a switching power supply system with the TRIAC dimmer according to an embodiment of the present invention. When a switching power supply system employs the TRIAC dimmer for dimming, different conduction angle of the TRIAC dimmer will cause input voltage Vin has different amplitude value. As shown in FIG. 8, input voltage Vin has a lower amplitude in a second input cycle. For the conventional switching power supply system as waveforms 8A shown, a peak value of input current Iin follows input voltage Vin, when amplitude of input voltage Vin decreases in the second input cycle, charge signal CHG representative of the total charge of output current Io decreases accordingly, which will cause flicker and shimmer of a LED load. However, for a switching power supply system according to an embodiment of the present invention as waveforms 8B shown, a power switch is turned OFF when charge signal CHG reaches a charge reference signal, and input current Iin decreases to zero in time which ensures the total charge of output current Io stable, and the flicker and shimmer of the LED load is eliminated.

It should be noted that a status of high logic or low logic of a signal may be interchanged to achieve same function. A set terminal or a reset terminal, and a non-inverting terminal or an inverting terminal of a logic circuit may be interchanged to achieve same function.

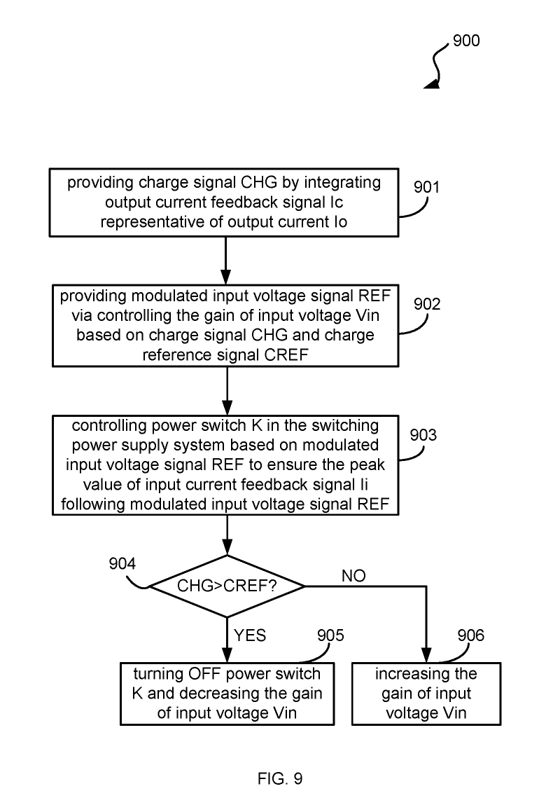

FIG. 9 shows a flow chart illustrating a control method 900 for a switching power supply system to eliminate flicker and shimmer of a LED load according to an embodiment of the present invention. The control method comprises steps 901-906. At step 901, providing charge signal CHG via integrating output current feedback signal Ic representative of output current Io. At step 902, providing modulated input voltage signal REF via controlling the gain of input voltage Vin based on charge signal CHG and charge reference signal CREF. In one embodiment, the gain of input voltage Vin is controlled based on a comparing result between charge signal CHG and charge reference signal CREF. At step 903, controlling power switch K in the switching power supply system based on modulated input voltage signal REF to ensure the peak value of input current feedback signal Ii following modulated input voltage signal REF. In one embodiment, controlling power switch K in the switching power supply system based on modulated input voltage signal REF comprises: comparing modulated input voltage signal REF with input current feedback signal Ii representative of input current Iin; power switch K is turned OFF until next switching period or next input cycle comes when input current feedback signal Ii is larger than modulated input voltage signal REF, and as a result, the peak value of input current feedback signal Ii follows modulated input voltage signal REF. At step 904, judging if charge signal CHG is larger than charge reference signal CREF. Once charge signal CHG is larger than charge reference signal CREF, enters step 905 to turn OFF power switch K and decrease the gain of input voltage Vin. Otherwise if charge signal CHG keeps less than charge reference signal CREF even when input voltage Vin decreases to zero, enters step 906 to increase the gain of input voltage Vin.

In one embodiment, the switching power supply system comprises a switching circuit such as flyback converter. In one embodiment, the control method further comprises providing an input current feedback signal via sensing an input current of the switching circuit, and providing an output current feedback signal via calculating from the input current feedback signal.

Note that in the flow chart described above, the box functions may also be implemented with different order as shown in FIG. 9. For example, two successive box functions may be executed meanwhile, or sometimes the box functions may be executed in reverse order.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

I/We claim:

1. A control circuit for a switching power supply system, the switching power supply system comprises a switching circuit having an input voltage, an input current and an output current, the control circuit comprising:
an integrating circuit, configured to receive an output current feedback signal representative of the output current, and configured to provide a charge signal by integrating the output current feedback signal;
a charge control circuit, having a first input terminal, a second input terminal and an output terminal, wherein the first input terminal is configured to receive the charge signal, and the second input terminal is configured to receive a charge reference signal; and
a switching control circuit, having an input terminal and an output terminal, wherein the input terminal is coupled to the output terminal of the charge control circuit, and the output terminal is configured to provide a switching control signal to control the switching circuit based on the charge signal and the charge reference signal.

2. The control circuit of claim 1, wherein the charge control circuit further comprises:
a gain control circuit, having a first input terminal, a second input terminal and an output terminal, wherein the first input terminal is configured to receive the charge signal, the second input terminal is configured to receive the charge reference signal, and the output terminal is configured to provide a gain modulation signal based on the charge signal and the charge reference signal; and
a multiplying circuit, having an input terminal, a control terminal and an output terminal, wherein the input terminal is configured to receive the input voltage, the control terminal is coupled to the output terminal of the gain control circuit, and the output terminal is coupled to the input terminal of the switching control circuit to provide a modulated input voltage signal based on the gain modulation signal and the input voltage, wherein the gain modulation signal is configured to control a gain of the input voltage.

3. The control circuit of claim 2, further comprises a current feedback circuit, configured to sense the input current and provide an input current feedback signal, the control circuit is configured to control the switching circuit based on the input current feedback signal and the modulated input voltage signal, wherein when the input current feedback signal is larger than the modulated input voltage signal, the switching circuit is turned OFF.

4. The control circuit of claim 1, wherein the charge control circuit further comprises:
a charge reference signal generator, configured to provide the charge reference signal;
a charge comparison circuit, configured to receive the charge signal and the charge reference signal, and configured to provide a charge comparison signal via comparing the charge signal with the charge reference signal;
a gain modulation circuit, having an input terminal and an output terminal, wherein the input terminal is configured to receive the charge comparison signal;
a multiplying circuit, having an input terminal, a control terminal and an output terminal, wherein the input terminal is configured to receive the input voltage, the control terminal is coupled to the output terminal of the gain modulation circuit, and the multiplying circuit is configured to control a gain of the input voltage and provide a modulated input voltage signal at the output terminal of the multiplying circuit;
a first latch circuit, having a set terminal, a reset terminal and an output terminal, wherein the set terminal is configured to receive a detecting signal, the reset terminal is coupled to the charge comparison circuit to receive the charge comparison signal; and
an AND gate, having a first input terminal, a second input terminal and an output terminal, wherein the first input terminal is coupled to the output terminal of the switching control circuit, the second input terminal is coupled to the output terminal of the first latch circuit, and the output terminal is coupled to the switching circuit; wherein
when the charge signal is larger than the charge reference signal, the first latch circuit is reset to turn OFF the switching circuit; and wherein
when the detecting signal indicates that a new input cycle of the input voltage begins, the first latch circuit is set, and the switching circuit is turned ON and turned OFF by the switching control circuit.

5. The control circuit of claim 4, wherein the switching control circuit further comprises:
a current comparison circuit, having a first input terminal, a second input terminal and an output terminal, wherein the first input terminal is configured to receive the modulated input voltage signal, the second input terminal is configured to receive an input current feedback signal, and the output terminal is configured to provide a current comparison signal via comparing the input current feedback signal with the modulated input voltage signal; and
a second latch circuit, having a set terminal, a reset terminal and an output terminal, wherein the set terminal is configured to receive a set signal, the reset terminal is coupled to the output terminal of the current comparison circuit, and the output terminal is coupled to the first input terminal of the AND gate, and wherein the switching circuit is turned ON based on the set signal, and the switching circuit is turned OFF based on the current comparison signal.

6. The control circuit of claim 4, wherein the gain modulation circuit is configured to provide a gain increasing signal and a gain decreasing signal to the multiplying circuit, and wherein
when the charge signal is larger than the charge reference signal, or when the input voltage decreases to zero, the gain decreasing signal transits to a first state from a second state, and when a TRIAC dimmer is turned ON, the gain decreasing signal transits to the second state from the first state;
when the input voltage decreases to a predetermined voltage threshold, the gain increasing signal transits to the first state from the second state, and when the TRIAC dimmer is turned ON, the gain increasing signal transits to the second state from the first state;
when the gain increasing signal is the first state and the gain decreasing signal is the second state, the gain of the input voltage increases;
when the gain increasing signal is the second state and the gain decreasing signal is the first state, the gain of the input voltage decreases; and
when both of the gain increasing signal and the gain decreasing signal are the first state or when both of the gain increasing signal and the gain decreasing signal are the second state, the gain of the input voltage maintains.

7. The control circuit of claim 4, wherein the charge reference signal generator further comprises:
a low pass filter, having an input terminal and an output terminal, wherein the input terminal is configured to receive the input voltage, and the output terminal is configured to provide an average of the input voltage via implementing a low pass filtering operation on the input voltage during a time period; and
a clamp circuit, having an input terminal and an output terminal, wherein the input terminal is coupled to the output terminal of the low pass filter, and the output terminal is configured to provide the charge reference signal, the charge reference signal is updated to equal the average of the input voltage at an end of the time period.

8. The control circuit of claim 1, further comprises a signal converting circuit, having an input terminal and an output terminal, wherein the input terminal is configured to receive an input current feedback signal representative of the input current, and the output terminal is configured to provide the output current feedback signal based on the input current feedback signal.

9. A switching power supply system, comprising:
a rectifier circuit, having an input terminal and an output terminal, wherein the input terminal is configured to receive an AC input voltage, and the output terminal is configured to provide an input voltage via rectifying the AC input voltage;
a switching circuit, having an input terminal and an output terminal, wherein the input terminal is coupled to the output terminal of the rectifier circuit to receive the input voltage, and wherein the switching circuit further comprises a power switch having a control terminal, the output terminal of the switching circuit is configured to provide an output current to drive a load via turning ON and turning OFF the power switch; and
a control circuit, configured to provide a charge signal by integrating an output current feedback signal representative of the output current, and the control circuit is configured to provide a switching control signal to control the power switch based on the charge signal.

10. The switching power supply system of claim 9, wherein the control circuit further comprises:
a gain control circuit, having a first input terminal, a second input terminal and an output terminal, wherein the first input terminal is configured to receive the charge signal, the second input terminal is configured to receive a charge reference signal, and the output terminal is configured to provide a gain modulation signal based on the charge signal and the charge reference signal;
a multiplying circuit, having an input terminal, a control terminal and an output terminal, wherein the input terminal is coupled to the input terminal of the switching circuit, the control terminal is coupled to the output terminal of the gain control circuit, and the output terminal is configured to provide a modulated input voltage signal based on the gain modulation signal and the input voltage; and
a switching control circuit, having a first input terminal, a second input terminal, and an output terminal, wherein the first input terminal is coupled to the output terminal of the multiplying circuit, the second input terminal is configured to receive an input current feedback signal representative of an input current of the switching circuit, and the output terminal is coupled to the control terminal of the power switch, wherein when the input current feedback signal is larger than the modulated input voltage signal, the power switch is turned OFF.

11. The switching power supply system of claim 10, wherein the control circuit further comprises:
a low pass filter, having an input terminal and an output terminal, wherein the input terminal is configured to receive the input voltage, and the output terminal is configured to provide an average of the input voltage; and
a clamp circuit, having an input terminal and an output terminal, wherein the input terminal is coupled to the output terminal of the low pass filter, and the output terminal is configured to provide the charge reference signal based on the average of the input voltage.

12. The switching power supply system of claim 9, further comprises a TRIAC dimmer, coupled between the AC input voltage and the input terminal of the rectifier circuit.

13. The switching power supply system of claim 9, wherein the switching circuit comprises a flyback converter.

14. The switching power supply system of claim 9, wherein the control circuit further comprises:
a current feedback circuit, configured to provide an input current feedback signal by sensing an input current of the switching circuit;
a charge comparison circuit, configured to provide a charge comparison signal via comparing the charge signal with a charge reference signal;
a gain modulation circuit, configured to receive the charge comparison signal and configured to provide a gain increasing signal and a gain decreasing signal;
a multiplying circuit, having an input terminal, a control terminal and an output terminal, wherein the input terminal is coupled to the input terminal of the switching circuit, the control terminal is coupled to the gain modulation circuit to receive the gain increasing signal and the gain decreasing signal, and the output terminal is configured to provide a modulated input voltage signal based on the input voltage and a gain of the input voltage, wherein the gain of the input voltage is regulated by the gain increasing signal and the gain decreasing signal;
a current comparison circuit, having a first input terminal, a second input terminal and an output terminal, wherein the first input terminal is coupled to the output terminal of the multiplying circuit to receive the modulated input voltage signal, the second input terminal is configured to receive the input current feedback signal, and the output terminal is configured to provide a current comparison signal via comparing the input current feedback signal with the modulated input voltage signal; and
a second latch circuit, having a set terminal, a reset terminal and an output terminal, wherein the set terminal is configured to receive a set signal, the reset terminal is coupled to the output terminal of the current comparison circuit to receive the current comparison signal, wherein the power switch is turned ON based on the set signal, and the power switch is turned OFF when the input current feedback signal increases larger than the modulated input voltage signal.

15. The switching power supply system of claim 14, wherein
when the charge signal is larger than the charge reference signal, or when the input voltage decreases to a first voltage threshold, the gain decreasing signal transits to a first state from a second state, and when a TRIAC dimmer is turned ON, the gain decreasing signal transits to the second state from the first state;
when the input voltage decreases to a second voltage threshold which is larger than the first voltage threshold, the gain increasing signal transits to the first state from the second state, and when the TRIAC dimmer is turned ON, the gain increasing signal transits to the second state from the first state;
when the gain increasing signal is the first state and the gain decreasing signal is the second state, the gain of the input voltage increases;
when the gain increasing signal is the second state and the gain decreasing signal is the first state, the gain of the input voltage decreases; and
when both of the gain increasing signal and the gain decreasing signal are the first state or when both of the gain increasing signal and the gain decreasing signal are the second state, the gain of the input voltage maintains.

16. The switching power supply system of claim 14, wherein the control circuit further comprises:
a first latch circuit, having a set terminal, a reset terminal and an output terminal, wherein the set terminal is configured to receive a detecting signal, the reset terminal is coupled to the charge comparison circuit to receive the charge comparison signal; and
an AND gate, having a first input terminal, a second input terminal, and an output terminal, wherein the first input terminal is coupled to the output terminal of the second latch circuit, the second input terminal is coupled to the output terminal of the first latch circuit, and the output terminal is configured to provide the switching control signal to the control terminal of the power switch; wherein
when the charge signal is larger than the charge reference signal, the first latch circuit is reset to turn OFF the power switch; and wherein
when the detecting signal indicates that a new input cycle of the input voltage begins, the first latch circuit is set, and the power switch is controlled by the second latch circuit.

17. The switching power supply system of claim 9, further comprises:
a detecting circuit, configured to provide a detecting signal based on the input voltage to indicate if a new input cycle of the input voltage begins; wherein
when the input voltage jumps, the detecting signal comprises a pulse to indicate that the new input cycle of the input voltage begins.

18. A control method for a switching power supply system, the switching power supply system comprises a switching circuit having an input voltage, an input current and an output current, the control method comprising:
providing a charge signal by integrating an output current feedback signal representative of the output current;
providing a modulated input voltage signal via controlling a gain of the input voltage based on the charge signal and a charge reference signal;
controlling the switching circuit based on the modulated input voltage signal; and
judging if the charge signal is larger than the charge reference signal; wherein
when the charge signal is larger than the charge reference signal, turning OFF the switching circuit and decreasing the gain of the input voltage; and wherein
when the charge signal is less than the charge reference signal, increasing the gain of the input voltage.

19. The control method of claim 18, further comprising:
sensing the input current and providing an input current feedback signal; and
calculating the output current and providing the output current feedback signal based on the input current feedback signal.

20. The control method of claim 18, further comprising:
comparing an input current feedback signal representative of the input current with the modulated input voltage signal; and wherein
when the input current feedback signal is larger than the modulated input voltage signal, turning OFF the switching circuit; and wherein
when the input current is zero or when a new input cycle of the input voltage begins, turning ON the switching circuit.
